(19) United States
(12) Patent Application Publication
(10) Pub. No.: US 2019/0136832 A1
(43) Pub. Date: May 9, 2019

(54) ENERGY STORAGE AND RECOVERY

(71) Applicant: ISOPower Limited, Camberley (GB)

(72) Inventor: Ian Crossley, Camberley (GB)

(73) Assignee: ISOPower Limited, Camberley (GB)

(21) Appl. No.: 15/807,701

(22) Filed: Nov. 9, 2017

(51) Int. Cl. F03D 9/17; F03D 9/28; H02K 7/18; F03D 9/25

(52) U.S. Cl. CPC F03D 9/17; F03D 9/28; F05B 2240/95; F03D 9/257; F05B 2260/20; H02K 7/1838

(57) ABSTRACT

The gear box in conventional wind turbine systems is very complex, large, heavy and costly. In addition, large, heavy, complex and costly lube oil systems are required to remove heat generated by such gear boxes. Such complex systems require frequent maintenance and overhaul, requiring access even in offshore locations. A solution to these problems has been identified in the art by eliminating the requirement for a gear box and lube oil system by the invention of direct drive generators which generate at 50 Hz frequency at wind turbine speed, having a very large number of poles and being larger and heavier than the traditional four pole equivalents. The present invention includes a energy storage and recovery system whereby a wind turbine generates electricity at a predetermined frequency below 45 Hz which may then be used to compress air for subsequent expansion and generation of electricity at a grid frequency of 50 Hz.

### FIELD OF THE INVENTION

The present invention relates to energy storage and recovery, and finds particular, although not exclusive, utility in offshore wind power energy storage.

### BACKGROUND

The input torque from a relatively low-speed wind turbine is comparatively high, therefore the gear box required is both very complex and very large, heavy and costly. For example, for a 6 MW turbine the operating speed at rated power is typically 12 RPM which is much lower than the 50 HZ synchronous four pole generator speed of 1500 RPM required by the grid. This very large difference in rotational speed means that a gear box of very high ratio is required (usually three stages, one of epicyclic configuration, and two of parallel shaft helical configuration and of overall ratio 70 to 100). Such gear boxes because of their complexity, and because of the fluctuating speed and load imposed by a wind turbine have been a notorious source of the many breakdowns in wind turbine systems, and have established a reputation for unreliability in these systems.

Moreover, the gear box is a source of significant power loss because of the frictional heat developed within the many individual gear trains, and therefore a large, heavy, complex and costly lube oil system is required not only for lubrication, but principally to remove heat from the system.

Furthermore, a wind turbine does not operate at constant speed so there is also a need for a large, heavy and costly solid state frequency control system, to convert the fluctuating electrical output from the wind turbine generator to the stable output required by the grid.

The gear box, lube oil system and frequency control system have all to be incorporated in the wind turbine nacelle. Wind turbines are therefore top heavy and require strong and costly support systems. Having such equipment in the nacelle also means that wind turbines need to be provided with a permanent means of internal access to the nacelle for maintenance and overhaul.

A partial solution to these problems has been identified in the art by eliminating the requirement for a gear box and lube oil system by the invention of direct drive generators which generate at 50 Hz frequency at wind turbine speed. Such generators have a very large number of poles. Instead of a conventional four poles they may have as many as 300 poles in the stator to achieve generating frequencies of 50 Hz. Having such a large number of poles means that the generator needs to be of extremely large diameter relative to a four pole design. The poles also need to be of permanent magnet type as there is not enough space to accommodate wound poles in a machine of acceptable diameter to fit within a turbine nacelle.

Current direct drive generators eliminate a number of the traditional wind turbine problems but they are much larger and heavier, than the traditional four pole equivalents, and a large, heavy and costly frequency control system is still required in the nacelle.

### BRIEF SUMMARY

According to a first aspect of the present invention, there is provided an energy storage and recovery system, comprising: a wind turbine having a wind turbine generator configured to generate electricity at a predetermined frequency below 45 Hz (in particular below 30 Hz); a compressor for compressing gas, the compressor configured to receive electricity generated by the wind turbine, the compressor having a drive motor configured to operate at the predetermined frequency; and a pressure vessel for storing gas compressed by the compressor, the gas suitable for use in an expander for driving an expander generator.

The predetermined frequency may be below 15 Hz. The wind turbine generator may be configured to generate direct-current electricity, and the drive motor may be configured to operate on direct-current electricity, direct-current being a special case of alternating current in which the frequency is substantially 0 Hz. A direct current generator would be particularly suited to the very high torques and very slow speeds of wind turbines between 5 and 20 MW rating.

The predetermined frequency may correspond to a predetermined rotational frequency of the wind turbine; that is, the predetermined frequency may be determined as a product of a predetermined rotational frequency of the wind turbine and number of pole pairs present in the wind turbine generator. For instance, if the turbine were rotating at 20 rpm, and the wind turbine generator comprised 30 pole pairs, then the predetermined frequency would be given by 30×20 rpm/60=10 Hz. Alternatively, if the turbine were rotating at 12 rpm, and the wind turbine generator comprised 75 pole pairs, then the predetermined frequency would be given by 75×12 rpm/60=15 Hz. There may be, for instance between approximately 40 and 100 pole pairs, in particular 50 and 90, more particularly 60 and 80.

The wind turbine generator is configured to be incompatible with the grid. In this way, the system may be configured to use all the energy generated by the wind turbine (e.g. in its entirety) to produce compressed air for the storage system vessel. Similarly, energy recovered from the compressed air may be used solely for (and or may be entirely dedicated to) supplying electricity to the grid (e.g. the national grid).

The energy storage and recovery system may further comprise: an expander arranged to receive compressed gas from the pressure vessel; and/or an expander generator configured to generate electricity having a frequency in the range 50-60 Hz; wherein, the expander may be configured for driving the expander generator in response to expansion of the compressed gas.

In this way, avoiding any electrical connection between the wind turbine generator and the grid allows a free choice of wind turbine generator frequency and voltage. This enables the wind turbine generator and the associated compressor drive motor to be of a lower frequency than the 50 Hz grid frequency, (for example 5, Hz, 12.5 Hz, 25 Hz or 30 Hz). This low frequency would avoid the need for high ratio gear boxes and their associated complex lube oil systems which are needed to drive high speed or medium speed 50 or 60 Hz grid connected generators. At the same time it would facilitate the use of direct drive generators of much smaller size and weight than current types of direct drive generators, which because of the need to operate at 50 or 60 Hz have many more electrical poles than would be required by a low frequency system. The compressor drive motor would operate at the same frequency as the wind turbine generator.

The expander would drive the grid generator at normal 50, or 60 Hz grid frequency, which since it is driven only by the compressed stored air is never subject to the fluctuations in shaft power and speed which arise with a generator linked to the wind turbine. Hence the complexity of the generator control system, which has been a significant cost element in wind turbine systems to date, might be significantly reduced. With the system proposed therefore, at some loss of energy efficiency, capital cost savings and significant reductions in system complexity should accrue.

This invention is for a compressed air energy storage system applicable to offshore wind turbines in which all the power generated by the wind turbine is delivered to the storage system and none directly to the grid, so that the wind turbine generator and compressor motor can be designed, independently of the grid requirements, as low frequency machines or even direct drive machines. The low frequency wind turbine generator may then be directly driven from the wind turbine without any need for complex multi stage gears and their associated lube oil systems. Such a low speed, low frequency, direct drive generator will be of substantially lower size, weight and cost than a direct drive generator of 50 or 60 Hz design.

At least one of: the expander generator; the expander; an expander-generator set/system (comprising the expander generator and the expander); the pressure vessel; and/or the compressor; may be spaced from the turbine.

In this way, complex equipment may be placed away from the environment in which the turbine is located, which is often exposed. In some embodiments, the pressure vessel may take the form of a pipe for conveying pressurised air from the compressor to the expander; however, in other embodiments, a pipe is provided simply for transmitting the air, and does not form part of the pressure vessel. In some embodiments, electricity from the wind turbine generator may be conveyed at the predetermined frequency to compressors spaced away from the turbines.

In this way, the invention allows for the single compressed air storage vessel to be extended from offshore to land, acting as pipeline for the delivery of compressed storage air as well as a vessel. This consequently allows an expander-generator set to be shore based and connected directly to the land based grid without the need for any undersea transmission cables. The pipe may have a diameter of at least 3m, 4m, 5m or 6m. In this way, friction/pressure losses can be mitigated.

The pressure vessel may be configured to hold air at a pressure of up to 0.5 MPa, 1 MPa, 1.5 MPa, 2 MPa, 2.5 Mpa or 3 MPa.

A plurality of turbines may be used in a turbine array.

The pressure vessel may comprise a buoyancy chamber of an off-shore wind turbine. For instance, the buoyancy chamber may be a buoyancy column of an articulated wind column.

The pressure vessel may comprise an air-tight container configured to be located underwater, for instance on a sea bed.

This vessel may be of lightweight and/or low-cost construction, for instance of steel or concrete construction, since being located on the sea bed, the sea water pressure around the reservoir would counteract the pressure of the stored compressed air within the reservoir. The vessel may be spherical or cylindrical in shaped, or may be any other convenient shape for the environment into which it is to be placed. The vessel may be configured to operate as a displacement vessel; that is, when empty the vessel may be flooded with water, which would then be displaced when compressed air is supplied to the vessel. In this way, the pressure of air extracted from the vessel may remain constant.

The compressor and expander may be a single compressor-expander system/set. The expander may comprise the compressor being run in reverse. The drive motor and generator may be a combined motor-generator system. The generator may be the drive motor run in reverse. The compressors may be gear type compressors.

The compressor and expander may be combined into a single machine such that a subset of the impellers are dedicated to compressing air and a further distinct subset are dedicated to expanding the air. In any specific compression or expansion step, the unused impellers may be operated against closed inlet valves, or may be decoupled.

The compressor and/or expander may be single- or multi-stage, and the expander may be a turbo expander. In multi-stage compressors/expanders, valves in the inlet of each stage may be provided such that various combinations of stages may be bypassed consecutively as required, to mitigate for any decline/increase in storage vessel pressure, so that each expander stage can always be operated at near the optimum pressure ratio, and consequently at the best efficiency.

The system may further comprise an air drier to dry stored air, thereby preventing internal condensation and icing of the expander system during the energy recovery phase.

The expander may comprise a combustion system for increase the power available from the expander. The combustion system may be provided with a fuel supply. Alternatively or additionally, a heating system may be provided to heat the stored compressed air prior to submission into the expander; for instance via electrical heating or via the (or another separate) combustion system. However, it is preferred that such a combustion system is absent.

The energy storage and recovery system may further comprise: an expander arranged to receive compressed gas (e.g. air) from the pressure vessel, and configured for driving an expander generator in response to expansion of the compressed gas; and an expander heat exchanger connected to the expander such that heat is transferred from sea water within the expander heat exchanger to the gas used in the expander.

The energy storage and recovery system may further comprise: an expander arranged to receive compressed gas from the pressure vessel, and configured for driving an expander generator in response to expansion of the compressed gas; a compressor heat exchanger connected to the compressor such that heat is transferred from the gas compressed in the compressor to working fluid within the compressor heat exchanger; a working fluid reserve, for holding the working fluid from the heat exchanger; and/or an expander heat exchanger connected to the expander such that heat is transferred from the working fluid held within the working fluid reserve to the gas used in the expander.

In some embodiments, compressed air within the storage vessel may be supplied from an air compressor driven by an electric motor, for which the power is provided by means of the wind turbine generator of the wind turbine itself or from the electrical grid to which the expander generator is connected, thereby providing a means of storage capacity for the grid itself, for the benefit of other renewable energy sources such as solar or tidal energy etc. and also for the base load generating plant.

According to a second aspect of the present invention, there is provided a method of storing energy for subsequent recovery, the method comprising the steps of: providing an energy storage and recovery system according to any preceding claim; generate electricity at a predetermined frequency below 30Hz using a wind turbine generator of a wind turbine; receiving electricity generated by the wind turbine at a compressor; operating the drive motor of the compressor at the predetermined frequency to compress gas; and storing the compressed gas in a pressure vessel.

For most envisaged applications, the stored air will be at ambient temperature, since over the storage period any residual heat of compression will be lost to the atmosphere. Alternatively or additionally, during the compression phase the heat of compression may be extracted via intercoolers and aftercoolers and stored (for instance as hot water in an insulated vessel), thus making it available for later use in the energy recovery phase.

According to a third aspect of the present invention, there is provided an energy storage and recovery system, comprising: a compressor for compressing gas; a wind turbine arranged to drive the compressor; a pressure vessel for storing gas compressed by the compressor; an expander arranged to receive compressed gas from the pressure vessel, and configured for driving an expander generator in response to expansion of the compressed gas; and an expander heat exchanger connected to the expander such that heat is transferred from sea water within the expander heat exchanger to the gas used in the expander.

According to a fourth aspect of the present invention, there is provided an energy storage and recovery system, comprising: a compressor for compressing gas; a wind turbine arranged to drive the compressor; a pressure vessel for storing gas compressed by the compressor; an expander arranged to receive compressed gas from the pressure vessel, and configured for driving an expander generator in response to expansion of the compressed gas; a compressor heat exchanger connected to the compressor such that heat is transferred from the gas compressed in the compressor to working fluid within the compressor heat exchanger; a working fluid reserve, for holding the working fluid from the heat exchanger; and an expander heat exchanger connected to the expander such that heat is transferred from the working fluid held within the working fluid reserve to the gas used in the expander.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 shows an ‘articulated wind column’ or AWC supporting a wind turbine.

FIG. 2 shows how a compressor and an expander for recovering of the energy in compressed air, could be accommodated in the tower of the turbine of FIG. 1.

FIG. 3 shows three alternative options for the storage of compressed air suited to: a concrete gravity platform, a steel jacket platform, and an AWC.

FIG. 4 shows first a conventional arrangement for an energy storage system, and second illustrates a proposed system.

FIG. 5 illustrates an array of wind turbines configured according to proposed system of FIG. 4.

FIG. 6 shows an alternative arrangement to FIG. 5.

FIG. 7 shows a further alternative arrangement to FIGS. 5 and 6.

FIG. 8 is a still further alternative arrangement to FIGS. 5 to 7.

FIG. 9 is a still further alternative arrangement to FIGS. 5 to 8.

FIG. 10 shows various intercooler systems for use in/with a turbo-expander and generator.

FIGS. 11(A)-(D) show the expansion curves relating to the different operating modes of FIG. 10.

FIG. 12 illustrates how a three stage expander and the corresponding interheaters could be arranged to generate electrical power efficiently over the pressure ratio range.

FIG. 13 shows a four stage gear machine with four reversible impellers in two operational states.

FIG. 14 shows an alternative way in which a single gear type machine could perform both compressor and expander functions.

FIG. 15 shows an arrangement whereby working fluid in the heat exchangers, heated during compression could be stored for later re-use in the energy recovery phase.

FIG. 16 shows an alternative arrangement for hot water storage in which the same water is recycled and re-used.

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

### DETAILED DESCRIPTION

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any embodiment or aspect of the invention may be combined in any suitable manner, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The principles of the invention will now be described by a detailed description of at least one drawing relating to exemplary features of the invention. It is clear that other arrangements can be configured according to the knowledge of persons skilled in the art without departing from the underlying concept or technical teaching of the invention, the invention being limited only by the terms of the appended claims.

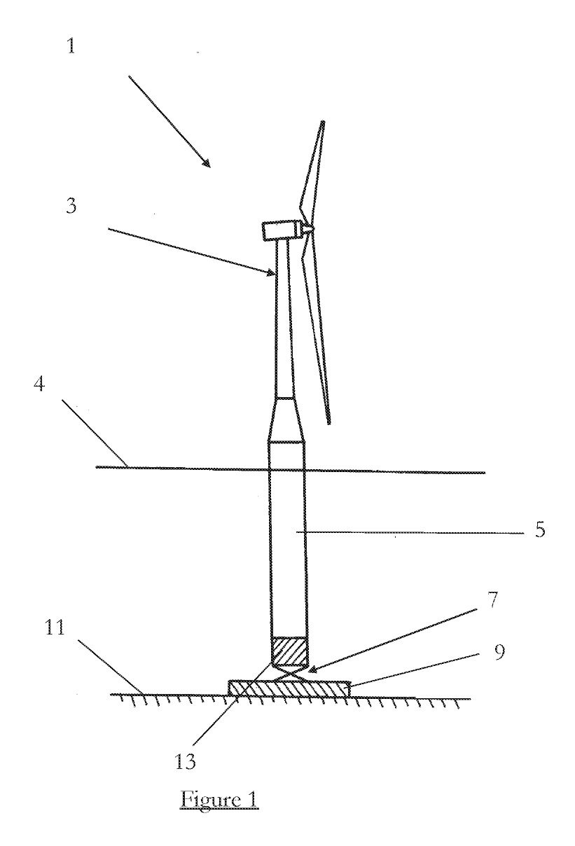

FIG. 1 shows an ‘articulated wind column’ or AWC 1 supporting a wind turbine 3 of approximately 6 MW rating positioned approximately 90 m above sea level 4. The blades of the turbine 3 are approximately 65 m long. The AWC 1 comprises a hollow substantially cylindrical vessel 5 (buoyancy chamber) constructed of steel or pre-stressed concrete with a diameter of approximately 12 m, coupled by an articulated joint 7 at its lower end, which is attached to a solid concrete base 9 on the sea floor 11. Ballast 13 is provided at the lower end of the vessel 5. The AWC 1 is described in detail in European patent application EP 2 441 893, and is shown in this figure in water of a depth of approximately 75 m.

The vessel 5 is configured to store compressed atmospheric air and can thus act as a means of energy storage. The internal volume of the buoyancy chamber for the support system shown in FIG. 1 would be approximately 10,000 cubic meters, which if pressurized with air at 1 MPa would, at atmospheric temperature, have a contained energy of some 6 MWh.

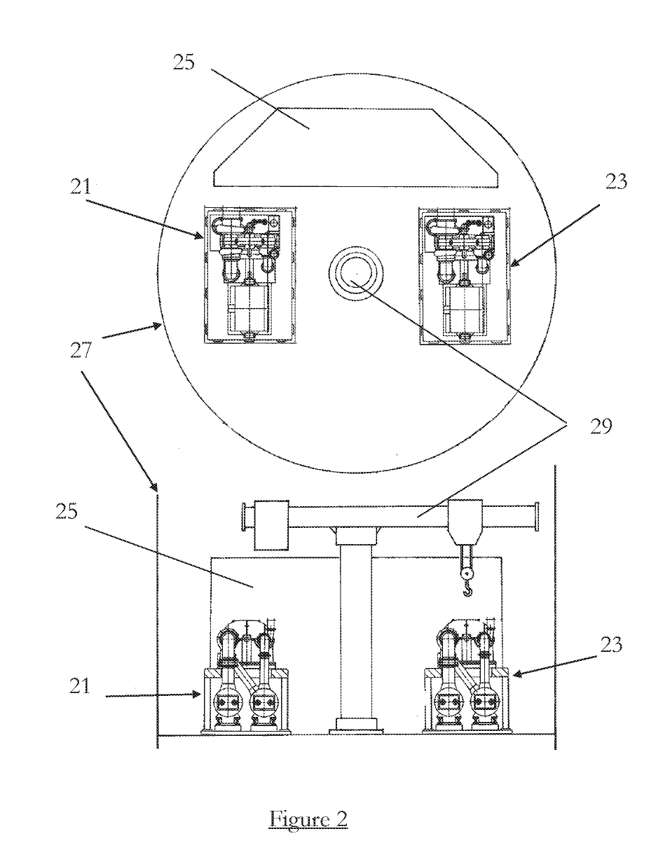

FIG. 2 shows how a compressor 21 and an expander 23 for recovering of the energy in the compressed air, could be accommodated in the tower of a turbine 3 located on an AWC structure, with an optional water reservoir 25 shown, first in a top view of the machinery room 27, and then in a side elevation cross-sectional view. Any necessary lube oil systems, coolers and drive motors for the compressor and a generator for the expander are included as would be understood by the skilled person. The drawing indicates that the available area within the machinery room would be adequate for the provision of a crane 29 and maintenance set down areas. The machinery room 27 could be constructed between the vessel 5 of the AWC 1, and the wind turbine support mast, and could have a height of 12 to 15 m. Alternatively, the compressor 21 and expander 23, and the reservoir 25 could be housed within the vessel 5 of the AWC 1.

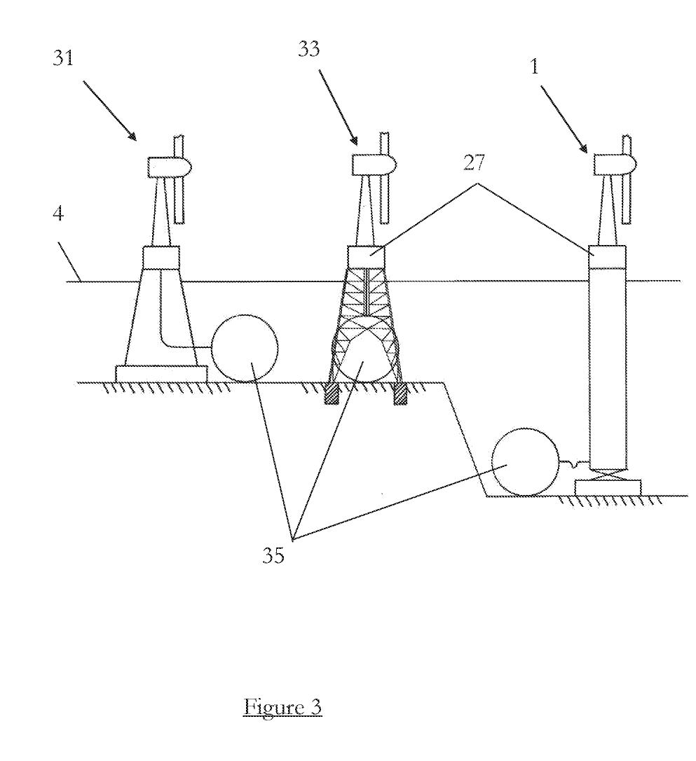

FIG. 3 shows three alternative options for the storage of compressed air: a concrete gravity platform 31, a steel jacket platform 33, and an AWC 1. The machinery room 27 is shown above sea level 4, and separate sea bed storage reservoirs 35 are shown for storing compressed air in accordance with the present invention. In the case of the AWC, the separate sea bed storage reservoir 35 is an optional component.

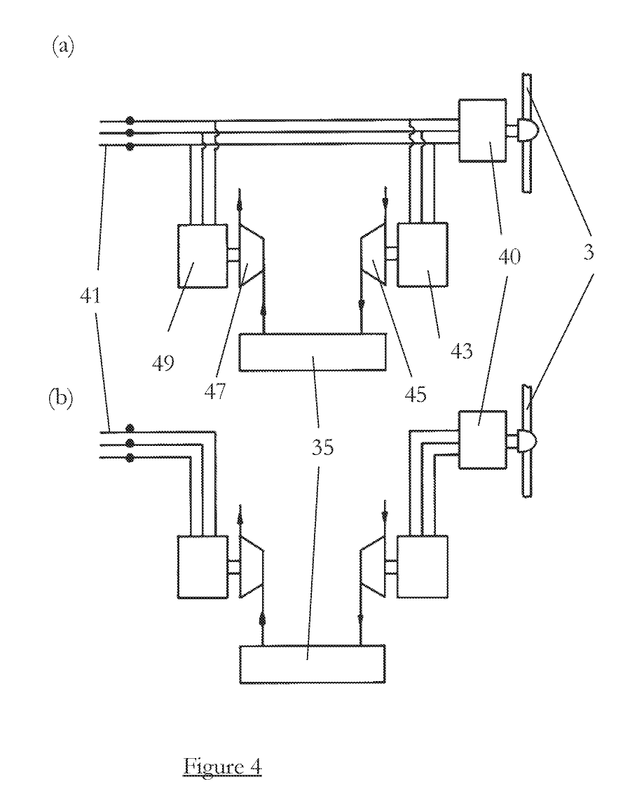

FIG. 4a shows a conventional arrangement for an energy storage system, in which electricity generated by the turbine 3 (at generator 40) is conveyed directly to the grid 41, except in cases when grid 41 demand is low, in which case it is used to compress gas (via motor 43 and compressor 45) for later expansion (using turbo expander 47 and generator 49) when grid demand is high. FIG. 4b illustrates a proposed system in which there is no direct connection to the grid by the wind turbine, such that the turbine need not generate electricity at grid-compatible frequencies. Rather, the turbine may generate electricity at the most convenient frequency, such that machinery, complexity and cost may be kept to a minimum.

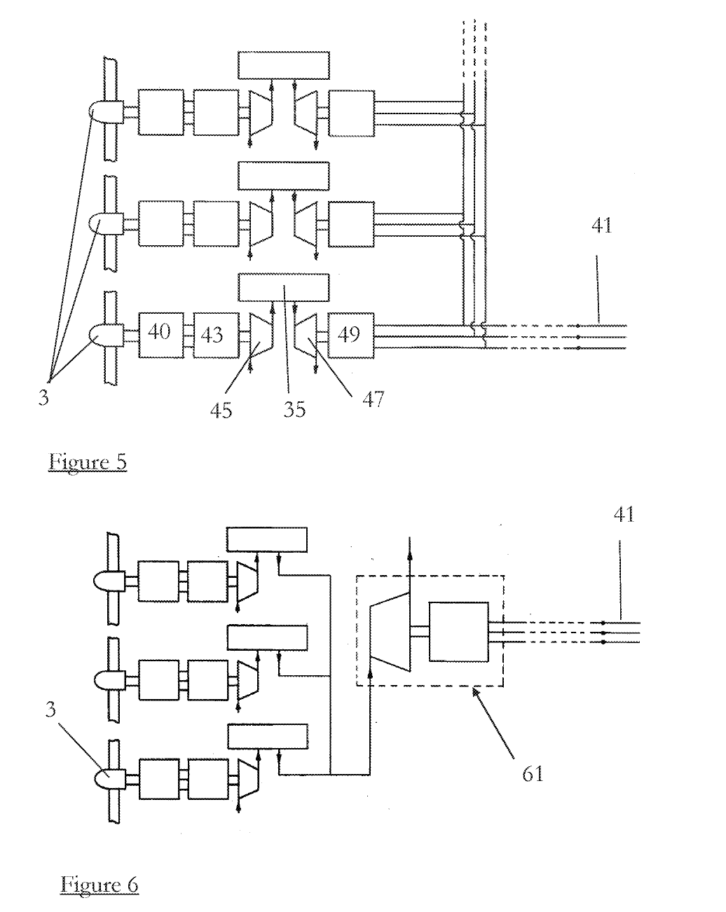

FIG. 5 illustrates an array of wind turbines configured according to the principle of FIG. 4b.

FIG. 6 shows an alternative arrangement to FIG. 5, in which a single large expander-generator set 61 is used, for instance mounted on an offshore platform to accept compressed air from each individual wind turbine reservoir. This would offer significant economies of scale in the expander-generator system and the associated control system and reduce the complexity and cost of the 50 Hz electrical grid in that there would be no need to connect each individual wind turbine to the grid.

FIG. 7 shows a further alternative arrangement to FIGS. 5 and 6 in which a single large central pressure vessel 71 is provided on the sea bed in the vicinity of the expander-generator set 61.

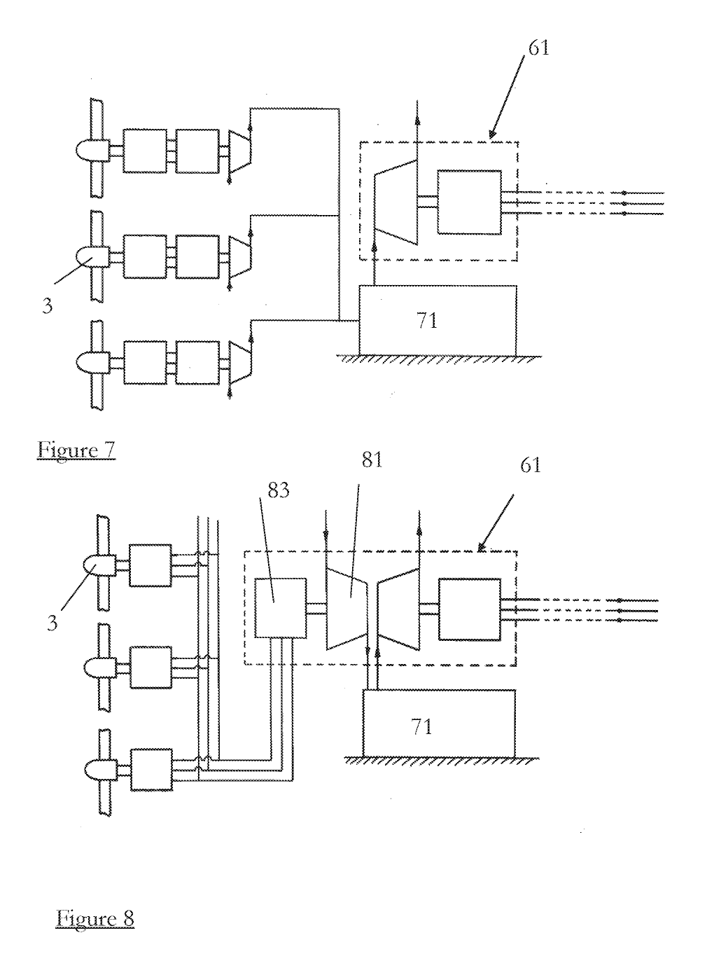

FIG. 8 is a still further alternative arrangement in which a single large compressor 81 and drive motor 83 is provided, preferably together with the expander-generator set 61.

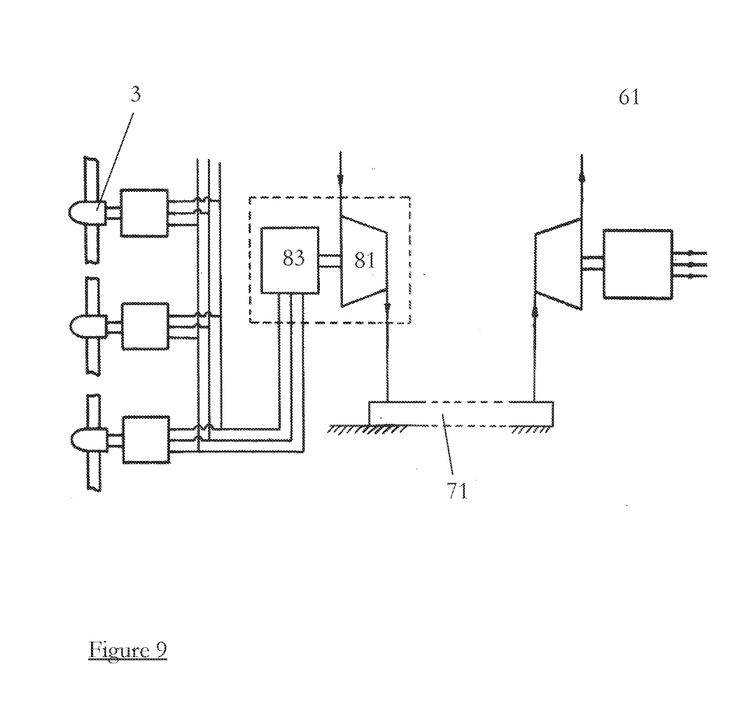

FIG. 9 is a still further alternative arrangement in which the pressure vessel 71 connects between the wind turbines 3 and the shore. In this case the expander-generator set 61 is be shore based, at a suitable location to connect with the mainland grid. In this configuration the cost and complexity of undersea electrical cabling could be entirely eliminated. A further modification that would be possible, and would be particularly easy to employ in the arrangement of FIG. 9, would be to include a liquid or gaseous fuel supply and a combustion system within the expander to enhance the power generated in the recovery phase of operation.

Combinations of each of the features discussed above are also considered.

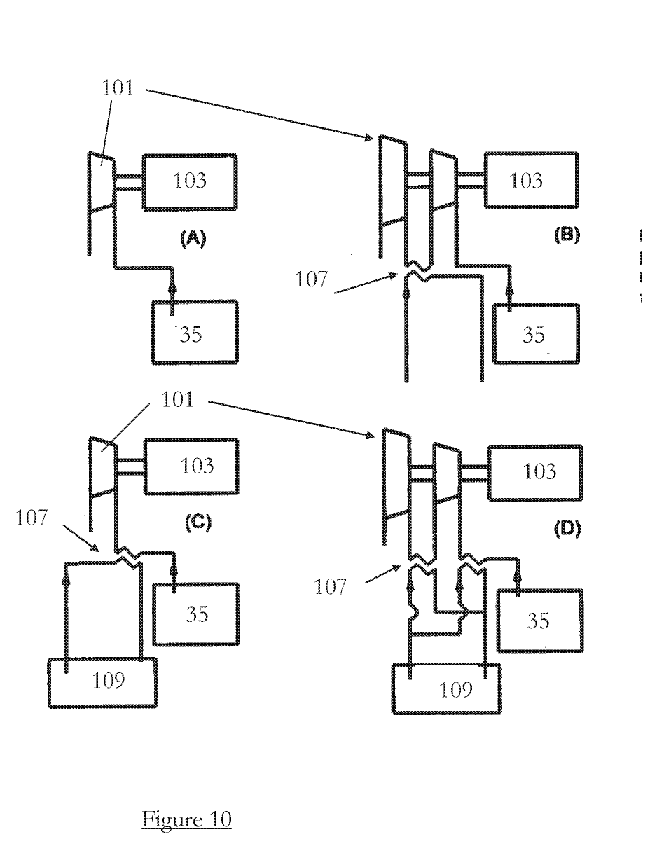

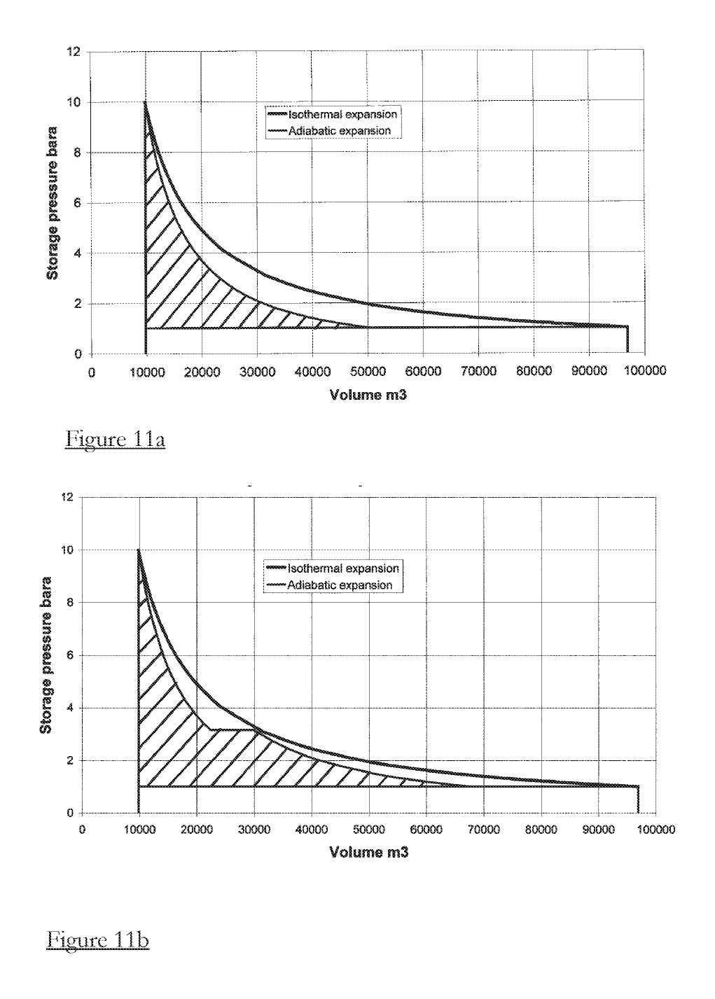

FIG. 10 shows various intercooler systems for use in/with the turbo-expander 101 and generator 103, when expanding air from the pressure vessel 105. (A) shows a single stage expander with no intercooler. (B) shows an arrangement in which a two stage expander incorporates an interstage heat exchanger 107 which can be supplied with ambient temperature sea water to increase the energy recovered and the power output of the expander. In this configuration the system acts as a heat pump extracting heat energy from the sea water, as the sea water is above the temperature of the expanding air so that a temperature difference for heat transfer prevails. Although a two stage expander is shown, three, four or more expander stages could be employed to increase power and energy recovery as is known in the art.

(C) shows how using a hot water reservoir could increase the power and energy recovery in a single stage expander by preheating of the compressed air before expansion. The heated water may be provided by supplying water to compressor intercoolers during compression (i.e. during energy storage). This heated water may be stored in an insulated vessel 109.

(D) shows a two stage expander in which hot water is used in a preheater as in (C), and also in an interstage heater similar to (B) for even greater power and energy recovery. With additional expander stages and interstage heaters the energy recovered could be further increased.

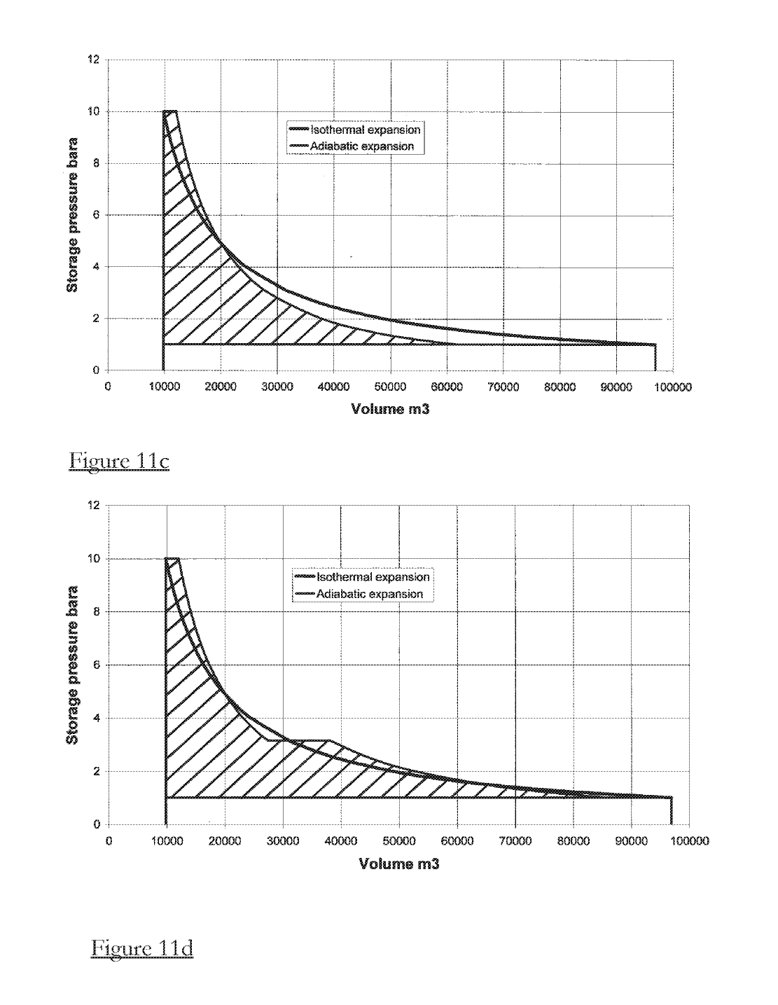

FIG. 11(A)-(D) show the expansion curves relating to the different operating modes of FIG. 10. The shaded areas below the adiabatic curves indicate the relative amounts of recovered energy with each system.

In any system for storage of compressed air, in which the reservoir pressure reduces in the energy recovery phase of operation, there is a difficulty in achieving a high efficiency in the expander because the expansion ratio reduces significantly as the storage reservoir is depleted.

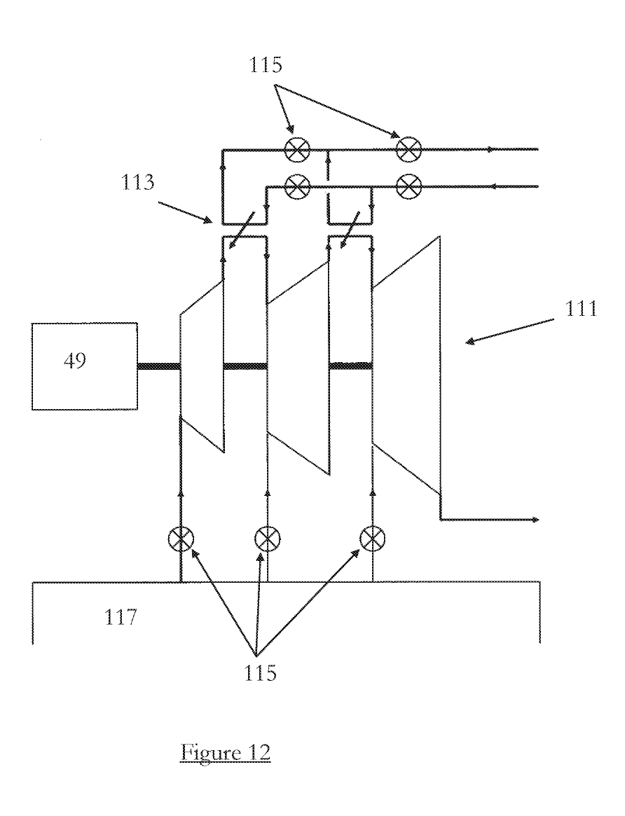

FIG. 12 illustrates how a three stage expander 111 and the corresponding interheaters 113 could be arranged to generate electrical power efficiently over the pressure ratio range. Valves 115 are installed between the vessel 117 and expander 111, and in the interheaters 113, so that the first and second stages of the expander can be consecutively bypassed as the reservoir is depleted. This ensures that the expander stages can be operated at the optimum pressure ratio and at the best efficiency throughout the energy recovery phase.

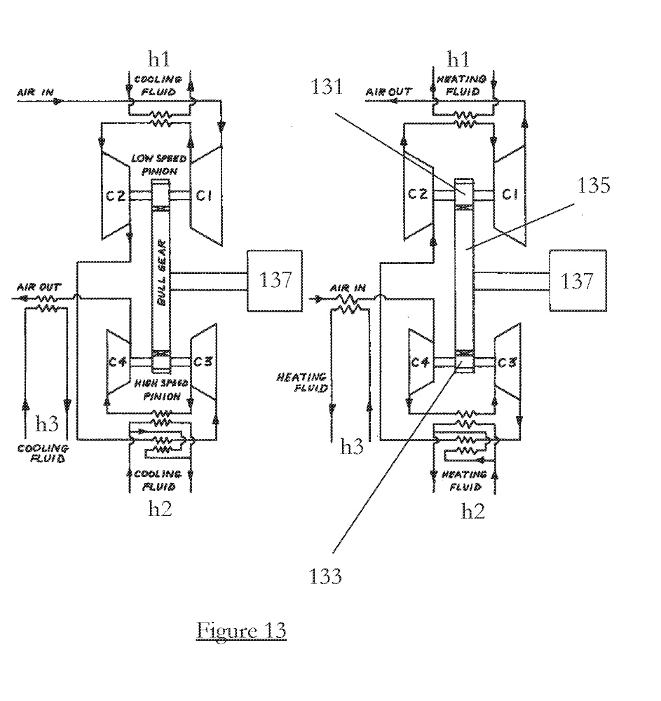

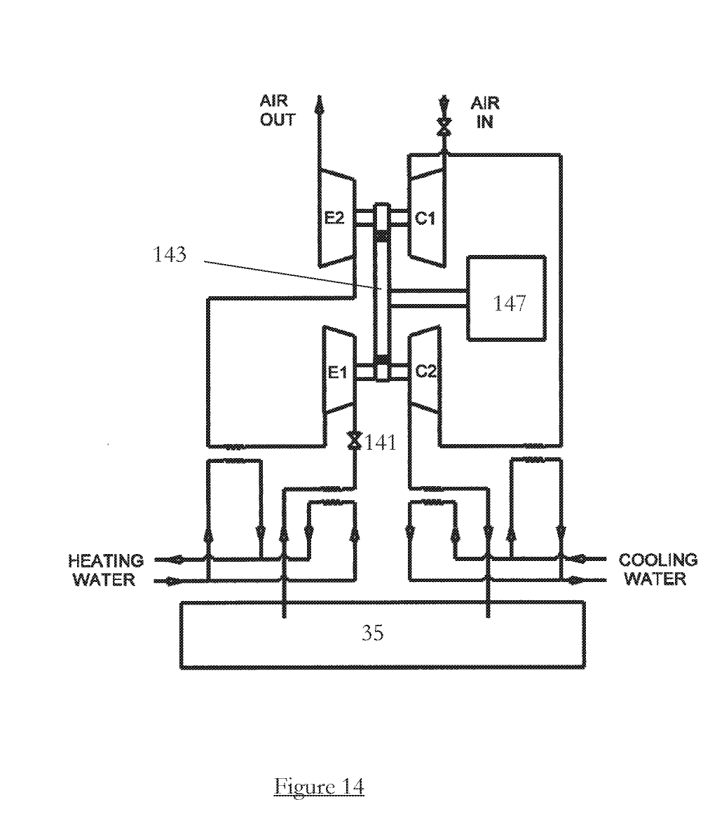

FIG. 13 shows a four stage gear machine with four reversible impellers (c1, c2, c3 and c4) in two operational states. The left-hand state shows the compressor mode of operation; the right-hand state shows the expander mode of operation. The impellers cl, c2, c3, c4 are coupled by pinions (respectively low 131 and high 133 speed) to a bull gear 135 that is itself coupled to a driver-generator motor 137.

In the compressor mode, air is received and passed to impeller c1 where it is compressed due to operation of the motor 137, then cooled in heat exchanger h1 before being passed to impeller c2, whereupon it is cooled in heat exchanger h2, passed to impeller c3, returned to heat exchanger h2 where it is cooled still further, sent to impeller c4 and finally cooled in heat exchanger h3 before being sent to the pressure vessel. The working fluid in the heat exchangers h1, h2, h3 that has been heated up by compression of the air is stored for further use.

In the expansion mode, air is heated in heat exchanger h3 on its way to be taken from the pressure vessel to impeller c4, where expansion drives the motor 137. It is heated in heat exchanger h2, expanded by impeller c3, heated again in heat exchanger h2, expanded in impeller c2, heated in heat exchanger h1 and expanded in impeller c1 before being exhausted.

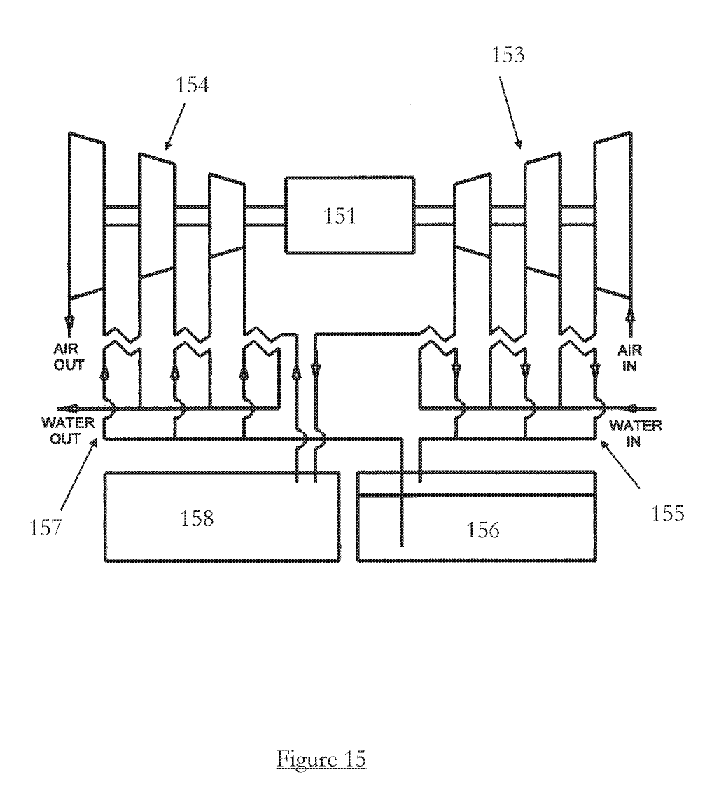

FIG. 14 shows an alternative way in which a single gear type machine could perform both compressor and expander functions. In compressor mode the dedicated expander impellers E1 and E2 would be de-coupled from the motor 147, or alternatively a valve 141 between E1 and the compressed air storage vessel could be closed. In expander mode the compressor impellers C1 and C2 would be decoupled, or alternatively the valve between C1 and the atmosphere could be closed. With extra pinions driven from the bull gear 143, more compressor and expander impeller stages, and more intercooler and interheater stages, could be added to this system with consequent improvement in efficiency.

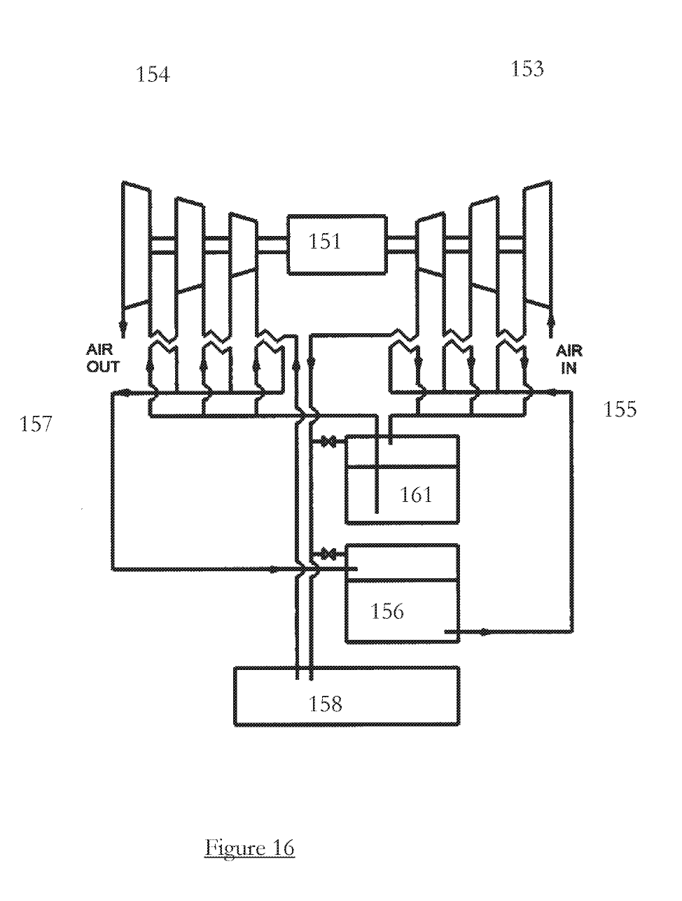

FIG. 15 shows an arrangement whereby working fluid in the heat exchangers, heated during compression could be stored for later re-use in the energy recovery phase. A motor 151 drives compressors 153, and can be driven by turbo expanders 154. An intercooler 155 takes ambient temperature sea water in, and stores the heated water in reservoir 156. In turn, this heated water may be used in interheater 157 to warm the compressed air from the vessel 158 during expansion. The figure shown is for a combined machine of in line impeller configuration, but could apply equally to separate compressor and expander sets and also to gear type machines. The water storage system could be a once through system in which separate water pumps may be for operation.

FIG. 16 shows an alternative arrangement for hot water storage in which the same water is recycled and re-used. In this arrangement the water could be circulated through the coolers 155 and heaters 157 by pressurizing the hot 156 and cold 161 water storage tanks from the pressure vessel 158, thereby eliminating the need for water pumps.

While various embodiments of devices, systems, and methods of using the same the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. An energy storage and recovery system, comprising:
a wind turbine having a wind turbine generator configured to be incompatible with grid power by generat[[e]]ing electricity at a predetermined frequency below 45Hz;
a compressor for compressing gas, the compressor configured to receive electricity generated by the wind turbine, the compressor having a drive motor configured to operate at the predetermined frequency; and
a pressure vessel for storing gas compressed by the compressor;
an expander arranged to receive compressed gas from the pressure vessel; and
an expander generator configured to generate electricity, wherein the expander is configured for driving the expander generator in response to expansion of the compressed gas.

2. The energy storage and recovery system of claim 1, wherein the predetermined frequency is below 15 Hz.

3. The energy storage and recovery system of claim 2, wherein the wind turbine generator is configured to generate direct current electricity at the predetermined frequency, the drive motor is configured to operate on electricity at the predetermined frequency, and the predetermined frequency is zero Hz.

4. The energy storage and recovery system of claim 1, wherein the predetermined frequency corresponds to a predetermined rotational frequency of the wind turbine.

5. (canceled)

6. The energy storage and recovery system of claim 1, wherein
the expander generator is configured to generate electricity having a frequency in the range 50-60 Hz.

7. The energy storage and recovery system of claim 6, wherein at least one of:
the expander generator;
the expander;
the pressure vessel; and/or
the compressor;
is spaced from the turbine.

8. The energy storage and recovery system of claim 6, wherein a plurality of turbines may be used in a turbine array.

9. The energy storage and recovery system of claim 1, wherein the pressure vessel comprises a buoyancy chamber of an off-shore wind turbine.

10. The energy storage and recovery system of claim 1, wherein the pressure vessel comprises an air-tight container configured to be located underwater.

11. The energy storage and recovery system of claim 6, wherein the expander comprises a combustion system for increasing the power available from the expander.

12. The energy storage and recovery system of claim 1, further comprising:
an expander heat exchanger connected to the expander such that heat is transferred from sea water within the expander heat exchanger to the gas used in the expander.

13. The energy storage and recovery system of claim 1, further comprising:
a compressor heat exchanger connected to the compressor such that heat is transferred from the gas compressed in the compressor to working fluid within the compressor heat exchanger;
a working fluid reserve, for holding working fluid for use in the compressor heat exchanger; and
an expander heat exchanger connected to the expander such that heat is transferred from the working fluid held within the working fluid reserve to the gas used in the expander.

14. A method of storing energy for subsequent recovery, the method comprising the steps of:
generating electricity at a predetermined frequency below 45 Hz using a wind turbine generator of a wind turbine;
receiving electricity generated by the wind turbine at a compressor;
operating a drive motor of the compressor at the predetermined frequency to compress gas; and
storing the compressed gas in a pressure vessel.
